(19) United States
(12) Patent Application Publication
(10) Pub. No.: US 2017/0080702 A1
(43) Pub. Date: Mar. 23, 2017

(54) PRINTING ROLLER AND METHOD FOR MOUNTING A PRINTING ROLLER

(71) Applicant: INOMETA GMBH, Herford (DE)

(72) Inventor: Christian Göhner, Vlotho (DE)

(21) Appl. No.: 15/124,498

(22) PCT Filed: Mar. 10, 2015
(86) PCT No.: PCT/DE2015/100094

§ 371 Date: Sep. 8, 2016

(30) Foreign Application Priority Data
Mar. 11, 2014 (DE) 10 2014 103 251.9

(51) Int. Cl. B41F 27/10; B41F 13/08

(52) U.S. Cl. CPC B41F 27/105; B41F 13/08

(57) ABSTRACT

A printing roller comprises a base body which has mounting segments, a printing and a clamping mechanism which has a clamping bushing, which can be displaced in the axial direction, and with respect to the clamping bushing, has a proximal and a distal clamping element which are arranged to detachably clamp the printing sleeve to the base body by means of the radial clamping force in each case, wherein a compression force transmission chain is formed between the clamping bushing and the proximal and the distal clamping elements, by means of which, during an initial clamping phase, the compression force, generated by the clamping bushing is transmitted predominantly or entirely to the distal clamping while the compression force generated by the clamping bushing is applied to the proximal clamping element to a lesser extent than to the distal clamping element or not at all.

The present disclosure refers to a printing roller and a method for mounting a printing roller.

### BACKGROUND

Printing rollers, in particular printing rollers for flexographic printing, usually make use of a base body, or roller base body, which functions as a support and at its ends has mounting elements or segments, which, when the printing roller is being utilised, are arranged in assigned mounting positions. A printing sleeve is detachably fixed onto the base body by means of various clamping technologies. Here provision can be made for the printing sleeve to sit on an adapter also arranged on the base body.

Various clamping mechanisms have been proposed for purposes of attaching the printing sleeve onto the base body such that it can be replaced.

A pneumatic form of clamping has been proposed. Here the printing sleeve has an internal diameter that is somewhat smaller than the external diameter of the base body. By means of the application of pneumatic pressure, the internal diameter of a base sleeve, which is a component of the adapter or printing sleeve, is expanded such that the printing sleeve can be pushed onto the supporting base body by hand. After the pneumatic compressed air has been switched off the internal diameter of the printing sleeve reduces once again, such that a force fit and friction fit is generated between the base body and the printing sleeve. The disadvantage of this technology is that the adapter, or the printing sleeve, has a flexible inner layer, and thus one that yields with the application of pneumatic pressure, and as a consequence an undesirable softness is introduced into the printing roller system.

Alternatively a hydraulic form of clamping of the printing sleeve onto the base body has been proposed. Here the base body has an internal hydraulic circuit, which expands expansion sleeves at outlets on the base body, and thereby clamps the printing sleeve onto the base body.

Furthermore, utilisation of a mechanical form of clamping has been proposed for purposes of fixing the printing sleeve onto the base body. In the document EP 0 527 293 A1 two conical clamping elements are utilised per clamping station; however, these are complex to produce and place high requirements on the production tolerances.

In the document EP 2 090 432 A1 a form of clamping by means of compression fittings is disclosed; these are actuated via an internally located tension rod in the hollow base body.

From the document EP 2 639 064 A1 a flexographic printing press with a printing roller supporting at least one printing plate, a counter-printing roller, and at least one application roller transferring the print colour directly onto the printing plate, is of known art. The application roller is composed of a roller core (base body), and a shell surrounding the roller core; the outer liner of the shell is provided with a screen, and on its inner liner the shell has at least one clamping surface, against which clamping devices can be clamped from the interior, wherein the clamping devices are components of the roller core. In one form of embodiment a printing sleeve is detachably and replaceably attached by means of a mechanical clamping mechanism onto the base body, with mounting elements at the ends. The clamping mechanism has a clamping bushing arranged such that it can be screwed onto the base body, together with a proximal and a distal clamping element under the action of the clamping bushing. A bushing is arranged between the proximal and the distal clamping element such that a compression force, provided with the aid of the clamping bushing, is transmitted from the clamping bushing onto the proximal clamping element, and from there, via the bushing, onto the distal clamping element. With the application of pressure, deformation effects occur in the clamping elements, which lead to a radial expansion of the clamping elements embodied as expansion elements, as a result of which the expansion elements clamp radially against a cylindrical clamping surface on the inner liner of the replaceable printing sleeve. Since the compression force developed by the clamping bushing in the course of an axial screwing action acts in the first instance directly onto the proximal expansion element, and only subsequently, via the bushing, onto the distal expansion element, the risk exists that when clamping the printing sleeve onto the base body the proximal clamping element expands in the first instance and clamps the printing sleeve, as a result of which the pressure necessary for purposes of expansion is no longer subsequently transmitted onto the distal clamping element.

In the document DE 197 22 460 C1 a mounting system for a cylindrical roller is disclosed. In order to be able to replace cylindrical rollers, preferably pressure cylinders, mounted at one free shaft end, easily and quickly with good centring and accurate axial alignment, the rollers have end faces in the form of covers, with cone-shaped bores, of which one bore is supported on a first counter-cone that is fixed to the shaft. On the shaft is mounted a second counter-cone that can be moved against a spring force; this engages in the other bore, and clamps the roller against the first counter-cone.

In the document DE 20 27 200 B2 a device for purposes of clamping a pressure cylinder is disclosed. In the device for purposes of clamping a pressure cylinder liner, embodied in its interior with a conical bore, on its cylindrical shaft, a centring cone pushed onto the cylindrical shaft is pressed against the corresponding conical inner surface of the pressure cylinder under the action of a compression spring acting in the axial direction. A flanged bushing is guided within an undercut of the centring cone; the said flanged bushing both internally supports the compression spring against the centring cone, and also externally supports the pressure cylinder liner, and is secured by means of a locating pin against axial detachment, wherein the cylindrical shaft, the centring cone and the flange bushing each have a longitudinal groove, in which a common locating spring engages.

### SUMMARY

The object of the invention is to specify a printing roller and a method for mounting a printing roller, in which the problems of the prior art have been overcome. In particular mounting and replacement of the printing sleeve on the supporting base body of the printing roller should be made possible, free from defects.

For purposes of achieving the object a printing roller in accordance with the independent claim 1 is proposed, together with a method for mounting a printing roller in accordance with the independent claim 11. Dependent claims specify advantageous configurations.

In accordance with one aspect a printing roller, in particular a flexographic printing roller, is provided with a base body and a printing sleeve. The base body has mounting segments or elements at its ends, which are arranged in assigned mounting stations when the printing roller is in use. With the aid of a clamping mechanism the printing sleeve on the base body can be detachably and replaceably clamped. The printing sleeve can be a sleeve, or a combination of a sleeve and an adapter on which the sleeve is arranged. In the case in which an adapter is used, the (outer) sleeve is arranged on the adapter on the printing sleeve, and the combination of sleeve and adapter forming the printing sleeve is clamped onto the base body.

The clamping mechanism has a clamping bushing that can be displaced on the base body in the axial direction, together with a proximal and a distal clamping element under the action of the clamping bushing. The clamping elements can run radially around the circumference in a continuous or discontinuous manner. The clamping bushing can be arranged such that it can be screwed onto the base body, so that the axial displacement is made possible by means of a screwing movement. By the influence of a compression or pressure force onto the proximal and distal clamping elements, generated by means of the clamping bushing in the course of the axial displacement, the printing sleeve is clamped onto the base body by means of the respective radial clamping force. The axial displacement of the clamping bushing generates a compression force, which is transmitted via a compression or pressure force transmission chain, which can also be designated as a compression force transmission mechanism, onto the proximal and the distal clamping elements, so that in each case a radially-acting clamping force is provided so as to clamp the printing sleeve onto the base body.

In the compression force transmission chain, when fixing the printing sleeve onto the base body in an initial clamping phase, the compression force generated by the clamping bushing is predominantly or entirely transmitted only onto the distal clamping element, so that the radial clamping force develops on the latter, while the compression force generated by the clamping bushing that is applied to the proximal clamping element is less than or zero compared with that applied to the distal clamping element. In one embodiment it is thereby achieved that in the initial clamping phase it is solely the distal clamping element that develops the radial clamping force, while the proximal clamping element is still free of any such radial clamping force. In this feasible configuration, it is only in a later clamping phase, which in terms of time follows on from the initial clamping phase, that a radially acting clamping force is developed by the proximal clamping element. Alternatively a radial clamping force can also be developed in the initial clamping phase, which, however, is less than the radial clamping force on the distal clamping element.

In one embodiment provision can be made for no mechanical contact to exist in the initial clamping phase between the clamping bushing and the proximal clamping element, so that the clamping bushing is free of any contact with the proximal clamping element. In this case the compression force transmission chain is not completed with respect to the connection between the clamping bushing and the proximal clamping element. In such a configuration it is only after the initial clamping phase that there is any traction between the clamping bushing and the proximal clamping element, in particular by means of a contact formed between them.

Alternatively or additionally, a compressible component can be arranged between the clamping bushing and the proximal clamping element, which is constituted so as to be compressed in the initial clamping phase; the transmission of pressure onto the proximal clamping element at least reduces the said compression, and only subsequently is a force transmission onto the proximal clamping element entirely effected. For example, a spring element can be provided, which is initially compressed, so as to effect a greater compression force transmission only after the initial clamping phase.

In accordance with a further aspect a method is provided for mounting a printing roller, in particular a flexographic printing roller. In the method a base body is provided, which has mounting segments at its ends. A printing sleeve is pushed onto the base body. The printing sleeve is subsequently clamped onto the base body (fixed by clamping) by means of a clamping mechanism, which has a clamping bushing that is arranged on the base body and can be displaced in the axial direction, together with a proximal and a distal clamping element under the action of the clamping bushing. During the clamping process a compression force is generated by means of axial displacement of the clamping bushing and is introduced onto the proximal and the distal clamping elements via a compression force transmission chain, which is formed between the clamping bushing and the proximal and distal clamping elements. The proximal and the distal clamping elements thus clamp the printing sleeve detachably onto the base body by means of respective radial clamping forces. In the method provision is made for the compression force transmission chain, when clamping the printing sleeve onto the base body in an initial clamping phase, to transmit the compression force generated by the clamping bushing predominantly or entirely onto the distal clamping element, so that the radial clamping force develops on the latter, which leads to the replaceable clamping of the printing sleeve onto the base body. During the initial clamping phase the compression force generated by the clamping bushing that is applied to the proximal clamping element, is less than or zero compared with that applied to the distal clamping element.

A preferred further development provides for the compression force transmission chain to be formed as a mechanical transmission chain. The mechanical transmission chain can be designed as one part, or in multiple parts. The mechanical transmission chain can be formed on the printing sleeve and/or on the base body. In adjacent elements or parts of the mechanical transmission chain, surfaces that are located opposite one another and associated with one another can be arranged so as to be located one above another. Alternatively or additionally, a compression force transmission chain can be provided, which is formed at least partly with a hydraulic transmission chain, for example, with a hydraulic ram, in which the compression force generated by the clamping bushing is applied to a hydraulic fluid so as to move a hydraulic piston that can be displaced in the hydraulic ram, which movement thus contributes to the force transmission in the compression force transmission chain.

The proximal and/or the distal clamping elements can be embodied with an expansion element. In the case of the expansion element the radial clamping force can be the consequence of a deformation effect when pressure is applied, such that the expansion element expands, and thus the radial force action is developed. Such expansion elements are as such of known art in various forms of embodiment.

The compression force transmission chain can have a protective element, or force introduction element, which is constituted so as to reduce, or to prevent entirely, the application of force onto the proximal clamping element with the compression force generated by the clamping bush in the initial clamping phase, in that the protective element provides a counterforce to the generated compression force. The protective element, or force introduction element, opposes, at least in the initial clamping phase, the compression force generated by the clamping bushing with a counterforce, which ensures that in the initial clamping phase the compression force applied to the proximal clamping element is not too great, or does not exist at all. The counterforce can, for example, prevent the clamping bushing and the proximal clamping element from coming into contact in the initial clamping phase, and can be provided by means of a spring element.

The protective element can have a pre-load element, which partially or entirely pre-loads the clamping bushing against any transmission of the compression force generated by the clamping bushing onto the proximal clamping element in the initial clamping phase. The pre-load element can be formed by a spring element, which pre-loads the clamping bushing against the transmission of the generated compression force onto the proximal clamping element. A plate spring can, for example, be deployed; in this or other configurations this can be arranged on the base body.

In one configuration provision can be made for the protective element to be constituted so as to move with the clamping bushing during the axial displacement of the latter. As in the case of the protective element, the pre-load element can also be arranged such that it can be axially displaced on the base body. The protective element can be mounted on the clamping bushing, for example, in an assigned recess on the clamping bushing. In the various forms of embodiment the protective element can be formed such that it runs radially around the clamping bushing in a continuous or discontinuous manner.

The protective element can be arranged on the printing sleeve such that the protective element can be separated, together with the printing sleeve, from the base body. In this form of embodiment the protective element can be a component of the printing sleeve, such that a common mounting and replacement of the printing sleeve and protective element is made possible.

In one configuration provision can be made for the compression force transmission chain, including the printing sleeve, to be formed such that the compression force generated by the clamping bushing can be transmitted via the printing sleeve onto the proximal and/or the distal clamping element. Here the printing sleeve is an element in the transmission chain for purposes of transmitting the compression force generated by the clamping bushing onto the proximal and/or the distal clamping element. In the case in which a protective element is provided, the protective element can form the element in the chain between clamping bushing and printing sleeve. In one form of embodiment the contact can be formed between protective element and printing sleeve in the region of the end face of the printing sleeve.

The proximal and/or the distal clamping element can be arranged in an assigned recess on the base body. The proximal and/or distal clamping element can be accommodated in a form fit in the assigned recess on the base body. A compression element can be provided such that it can be inserted into the recess in question; as a component of the compression force transmission chain the pressure element then presses against the relevant clamping element so as to develop the radial clamping force.

The proximal and the distal clamping element can be arranged in the radial direction at different distances from the central axis of the base body.

In conjunction with the method for mounting the printing roller, provision can be made for the clamping bushing and the proximal clamping element to be spaced apart from one another during the initial clamping phase. Thus no contact exists between the clamping bushing that can be displaced axially, and the proximal clamping element. For this period of time the compression force transmission chain is not completed up to the proximal clamping element. No force transmission takes place.

In a further development provision is made in the method for a mechanical element of the compression force transmission chain during the initial clamping phase to be displaced, at least temporarily, relative to the proximal clamping element, and in a later clamping phase to be clamped, by virtue of the radial clamping force then occurring on the proximal clamping element, and by this means fixed relative to the proximal clamping element. The mechanical element can, for example, take the form of a bushing or sleeve, which is arranged such that it can be displaced in the axial direction, for example on the base body, or in the base sleeve. During the relative displacement between the mechanical element and the proximal clamping element, surfaces of the two elements can slide one upon another.

### DESCRIPTION OF EMBODIMENTS

Following, further embodiments are described with reference to the figures. Here:

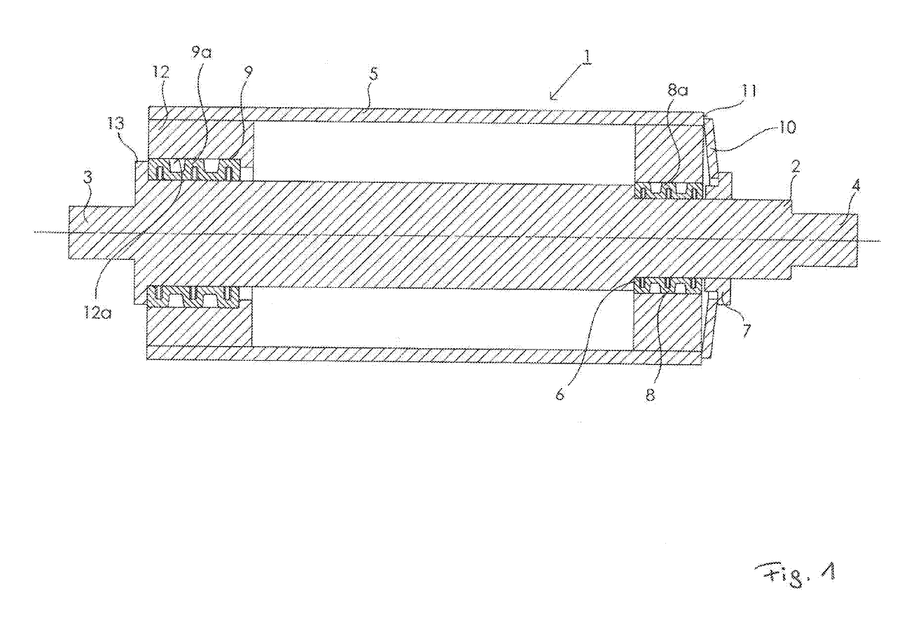

FIG. 1 shows a schematic representation of a printing roller in cross-section;

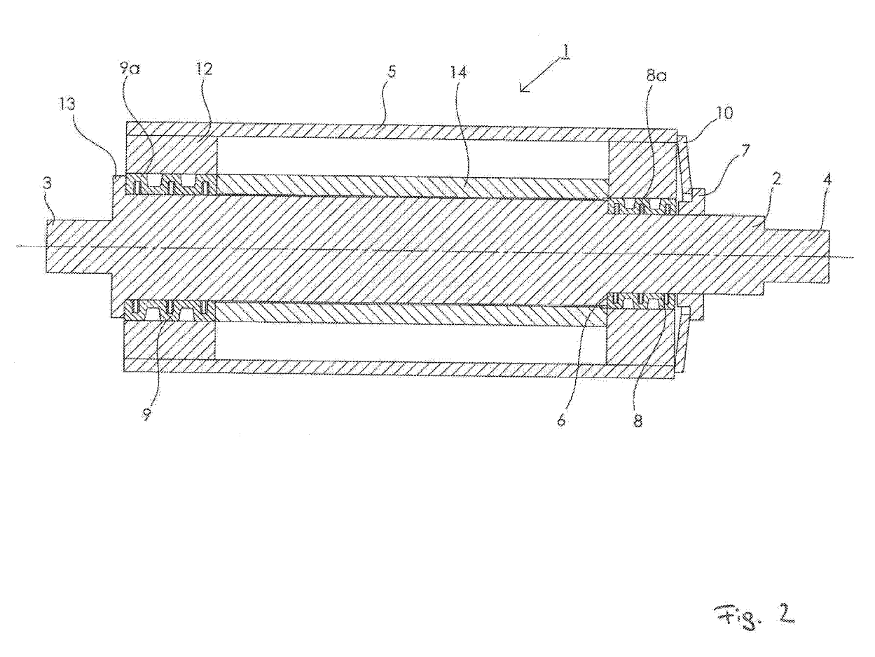

FIG. 2 shows a schematic representation of a further printing roller in cross-section; and

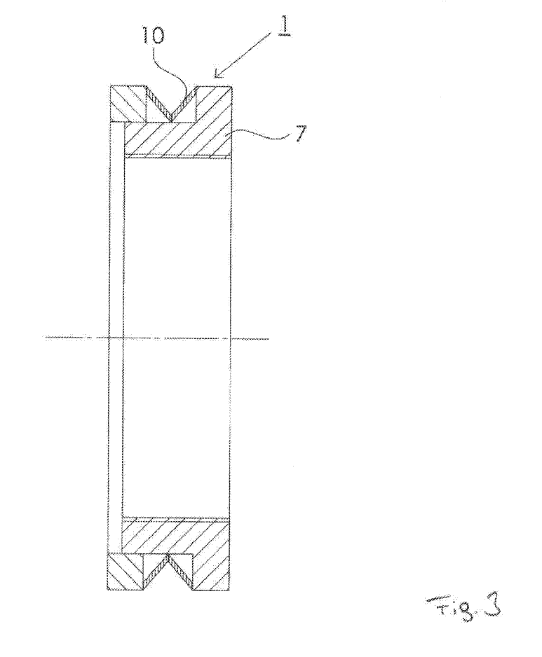

FIG. 3 shows a schematic representation of a clamping bushing with an integrated force introduction element for a printing roller.

FIG. 1 shows a schematic representation of a printing roller 1, in particular a printing roller for flexographic printing. The printing roller 1 has a base body 2, on which are formed mounting segments 3, 4 at its ends. On the base body 2, designed in the form of a support bar, a printing sleeve 5 is detachably and replaceably clamped with the aid of a clamping mechanism 6.

The printing sleeve 5 can be a sleeve, or a combination of a sleeve and an adapter, on which the sleeve is arranged. In the event that an adapter is used, the (outer) sleeve is arranged on the adapter on the printing sleeve 5, and the combination of sleeve and adapter forming the printing sleeve 5 is clamped onto the base body 2.

In the form of embodiment represented the clamping mechanism 6 has a clamping bushing 7, which is arranged such that it can be screwed onto the base body 2. By means of rotation (screwing action) the clamping bushing 7 can be displaced in the axial direction of the base body 2. The printing sleeve 5 serves to provide a compression force, which in the course of clamping the printing sleeve 5 onto the base body is transmitted onto a proximal clamping element 8 and a distal clamping element 9. FIG. 1 shows an unclamped initial state, in which the clamping bushing 7 is arranged spaced apart from the proximal clamping element 8. If the clamping bushing 7, by means of a screwing movement, is now moved in the axial direction towards the proximal clamping element 8, in an initial clamping phase the compression force provided by the clamping bushing 7 is transmitted via a protective element 10, which in the form of embodiment represented is embodied as a plate spring, and via an end face 11 of the printing sleeve 5, onto the latter. In turn the printing sleeve 5 couples mechanically, via a transmission element 12, onto the distal clamping element 9. The distal clamping element 9 is formed with a distal expansion element 9a, which, by virtue of the (lateral) application of pressure via the transmission element 12, is subjected to a deformation effect, which leads to the expansion of the expansion element 9a in the radial direction, so that the expansion element 9a presses against an inner surface 12a of the transmission element 12, and by this means against the printing sleeve 5. The deformation effect of the expansion element 9a takes place because, with the application of pressure, the expansion element 9a is pushed against a collar 13, and thus cannot escape the compression force. Instead the radial clamping force is generated for purposes of detachable clamping of the printing sleeve 5 onto the base support 2 in the region of the distal clamping element 9.

If the clamping bushing 7 moves further in the direction of the proximal clamping element 8, which is formed with a proximal expansion element 8a, the clamping bushing 7 thus finally comes into contact with the proximal clamping element 8, and applies a compression force onto the latter, which leads to an expansion of the proximal expansion element 8a in the radial direction, so that the printing sleeve 5 is finally also clamped in the region of the proximal clamping element 8 onto the base support 2.

FIG. 2 shows a schematic representation of a further printing roller, in which a detachable clamping action is provided in a comparable manner between the base body 2 and the printing sleeve 5. In contrast to the form of embodiment in FIG. 1, the compression force transmission chain in the configuration in FIG. 2 is formed with a transmission bushing 14, which for its part then presses onto the distal clamping element 9, as a result of which the expansion of the assigned expansion element 9a takes place. FIG. 2 also shows the printing roller in an initial clamping phase, in which the clamping bushing 7 is not in contact with the proximal clamping element 8.

FIG. 3 shows a schematic representation of a clamping bushing 7 with an integrated force introduction element 10, by which the clamping or releasing of the pressure sleeve 5 is accelerated since the clamping bushing with the force introduction element can be assembled or disassembled as one module onto the base body 2.

The features disclosed in the above description, the claims, and the figures, can be of significance, both individually and also in any combination, for the implementation of the various embodiments.

1. A printing roller (1), comprising:
a base body (2), comprising mounting segments (3, 4);
a printing sleeve (5), which is arranged on the base body (2); and
a clamping mechanism (6), comprising a clamping bushing (7) that can be displaced in an axial direction on the base body (2), and a proximal and a distal clamping element (8, 9) under the action of the clamping bushing (7), which are configured, upon application of a compression force generated by means of the clamping bushing (7) onto the proximal and distal clamping elements (8, 9), to clamp the printing sleeve (5) detachably onto the base body (2) by means of respective radial clamping forces;
wherein a compression force transmission chain is formed between the clamping bushing (7) and the proximal and distal clamping elements (8, 9), in which, when fixing the printing sleeve (5) onto the base body (2) in an initial clamping phase, the compression force generated by the clamping bushing (7) is predominantly or entirely transmitted onto the distal clamping element (9), so that the radial clamping force develops on the distal clamping element (9), while the compression force generated by the clamping bushing (7) that is applied to the proximal clamping element (8), is less than or zero compared with the compression force applied to the distal clamping element (9).

2. The printing roller in accordance with claim 1, wherein the compression force transmission chain is designed as a mechanical transmission chain.

3. The printing roller in accordance with claim 1, wherein at least one of the proximal and the distal clamping elements (8, 9) comprises an expansion element (8a, 9a).

4. The printing roller in accordance claim 1, wherein the compression force transmission chain has a protective element (10), which is constituted so as to reduce, or to prevent entirely, the application of force onto the proximal clamping element (8) with the compression force generated by the clamping bushing (7) in the initial clamping phase, in that the protective element (10) provides a counterforce to the generated compression force.

5. The printing roller in accordance with claim 4, wherein the protective element (10) has a pre-load element, which partially or entirely pre-loads the clamping bushing (7) against any transmission of the compression force generated by the clamping bushing (7) onto the proximal clamping element (8) in the initial clamping phase.

6. The printing roller in accordance with claim 4, wherein the protective element (10) is constituted so as to move with the clamping bushing (7) during the axial displacement of the clamping bushing (7).

7. The printing roller in accordance with claim 4, wherein the protective element (10) is arranged on the printing sleeve (5) such that the protective element (10) can be separated, together with the printing sleeve (5), from the base body (2).

8. The printing roller in accordance with claim 1, wherein the compression force transmission chain, including the printing sleeve (5), is formed such that the compression force generated by the clamping bushing (7) is transmitted via the printing sleeve (5) onto at least one of the proximal and the distal clamping element (8, 9).

9. The printing roller in accordance with claim 1, wherein at least on of the proximal and distal clamping elements (8, 9) is arranged in an assigned recess on the base body (2).

10. The printing roller in accordance with claim 1, wherein the proximal and distal clamping elements (8, 9) are arranged in a radial direction at different distances from a central axis of the base body.

11. A method for mounting a printing roller (1), wherein the method has the following steps:
providing a base body (2), which has mounting segments (3, 4),
arranging a printing sleeve (5) onto the base body (2), and
clamping of the printing sleeve (5) onto the base body (2) by means of a clamping mechanism (6), which has a clamping bushing (7) that is arranged on the base body (2) and can be displaced in an axial direction, together with a proximal and a distal clamping element (8, 9) under the action of the clamping bushing (7), wherein hereby:
a compression force is generated by means of axial displacement of the clamping bushing (7) and is introduced onto the proximal and the distal clamping elements (8, 9) via a compression force transmission chain, which is formed between the clamping bushing (7) and the proximal and distal clamping elements (8, 9), and
the proximal and distal clamping elements (8, 9) thereupon detachably clamp the printing sleeve (5) onto the base body (2) by means of respective radial clamping forces,
wherein the compression force transmission chain, when clamping the printing sleeve (5) onto the base body (2) in an initial clamping phase, transmits the compression force generated by the clamping bushing (7) predominantly or entirely onto the distal clamping element (9), so that the radial clamping force is developed on the distal clamping element (9), while the force generated by the clamping bushing (7) that is applied to the proximal clamping element (8), is less than or zero compared with the force applied to the distal clamping element (9).

12. The method in accordance with claim 11, wherein the clamping bushing (7) and the proximal clamping element (8) are spaced apart from one another during the initial clamping phase.

13. The method in accordance with claim 11, wherein a mechanical element of the compression force transmission chain during the initial clamping phase is at least temporarily displaced relative to the proximal clamping element (8), and in a later clamping phase, by virtue of the radial clamping force then occurring on the proximal clamping element (8), is clamped, and thereby fixed relative to the proximal clamping element (8).
